(19) United States
(12) Patent Application Publication
(10) Pub. No.: US 2018/0347792 A1
(43) Pub. Date: Dec. 6, 2018

(54) MODULAR ILLUMINATION ASSEMBLY

(71) Applicant: Amax Lighting, Inc., Santa Fe Springs, CA (US)

(72) Inventor: Michael Chen, Whittier, CA (US)

(21) Appl. No.: 15/613,094

(22) Filed: Jun. 2, 2017

(51) Int. Cl. F21V 21/005; F21S 8/06; F21S 8/04; F21V 14/00; F21V 19/00; F21V 23/04; F21V 21/008

(52) U.S. Cl. CPC F21V 21/005; F21S 8/061; F21S 8/046; F21V 21/008; F21V 19/008; F21V 23/04; F21V 14/00

(57) ABSTRACT

A modular illumination assembly provides at least one elongated light emitting diode lamp that joins other light emitting diode lamps in parallel series, through connecting junction boxes. The lamp comprises a shield that at least partially covers the lamp to directionally guide the emanated light in a desired direction. A pair of lamp holders provide circuitry and a switch for operation of the lamp. The lamp holders also comprise an adjustable retention member to fasten the termini of the lamp to restrict lateral slippage by the lamp. The lamp holders also comprise an anchor to receive a cable for hanging the light emitting diode lamp. The junction box forms an elongated ridge, and the lamp holder forms an elongated slot. The ridge and the slot slidably engage to enable detachable attachment between the junction box and the lamp holder, so as to connect multiple lamps in a parallel arrangement.

### FIELD OF THE INVENTION

The present invention relates generally to a modular illumination assembly. More so, the present invention relates to an illumination assembly that provides at least one elongated light emitting diode lamp that is adapted to join multiple light emitting diode lamps in parallel series through connecting junction boxes, and whereby the light emitting diode lamp comprises a shield that directionally guides the emitted light in a desired direction; and whereby a pair of lamp holders provide circuitry and a switch for operation of the lamp, and also comprise an adjustable retention member to fasten the termini of the lamp to restrict lateral slippage by the lamp, and also comprise an anchor to receive a cable for hanging the light emitting diode lamp: and whereby the junction box forms an elongated ridge and the lamp holder forms an elongated slot to enable detachable attachment therebetween, so as to form a series of parallel lamps.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, fluorescent lighting consists of long slender tubes, typically 4′ long with a diameter of LEDs emit light in a very narrow band of wavelengths, emitting light of a color characteristic of the energy bandgap of the semiconductor material used to make the LED. To emit white light from LEDs requires either mixing light from LEDs of various colors, or using a phosphor to convert sonic of the light to other colors.

Often, LED lamps attached at their ends to a housing that covers an upper portion of the lamps. The housing usually directs the light towards the ground and provides protection to the lamp. The housing also regulates electrical current to the lamp.

Generally, these LED lamps provide some beneficial features. However, they suffer from a number of limitations, including but not limited to, uneven light distribution and brightness, high material and component costs, difficult and time-consuming, assembly, and cumbersome housing configurations that hamper installation and thus prevent custom applications.

Other proposals have involved mounting LED lamps. The problem with these illumination devices is that the require a large, bulky housing to mount the lamps. Also, the emanated light is not directionally guided. Even though the above cited illuminating devices meet some of the needs of the market, a modular illumination assembly that provides at least one elongated light emitting diode lamp that is adapted to join multiple light emitting diode lamps in parallel series through connecting junction boxes, and whereby the light emitting diode lamp comprises a shield that directionally guides the emitted light in a desired direction, is still desired.

### SUMMARY

Illustrative embodiments of the disclosure are generally directed to a modular illumination assembly. The modular illumination assembly provides at least one elongated light emitting diode lamp that is adapted to join multiple light emitting diode lamps in parallel series through connecting junction boxes. The light emitting diode lamp comprises a shield that directionally guides the emitted light in a desired direction, such as towards a ground surface. A pair of lamp holders provide circuitry and a switch for operation of the lamp. The lamp holders also comprise an adjustable retention member to fasten the termini of the lamp to restrict lateral slippage by the lamp. The lamp holders also comprise an anchor to receive at least one cable for hanging the light emitting diode lamp. The junction box forms an elongated ridge, and the lamp holder forms an elongated slot. The ridge and the slot slidably engage to enable detachable attachment between the junction box and the lamp holder. In this manner, multiple lamps may be arranged in series.

In one aspect, a modular illumination assembly, comprises:

at least one elongated lamp operational to emanate light, the at least one lamp defined by a lamp sidewall and a pair of lamp terminal walls that form a cavity, the at least one lamp comprising a light emitting diode;
a shield disposed along a portion of the lamp sidewall, the shield being adapted to cover about half the lamp sidewall,
whereby the shield directionally guides the light emanating from the at least one lamp;
a pair of lamp holders retaining the pair of lamp terminal walls, the pair of lamp holders defined by a holder sidewall that forms a first mating surface, the pair of lamp holders comprising at least one adjustable retention member;
a circuitry and a switch for operation of the at least one lamp, the circuitry and the switch operatively connected to the pair of lamp holders and the at least one lamp;
at least one junction box defined by a junction box sidewall that forms a second mating surface, the at least one junction box operationally connected to the circuitry and the switch, the at least one junction box operational to regulate electrical current to the at least one lamp,
whereby the first mating surface of the pair of lamp holders detachably mates with the second mating surface of the at least one junction box,
whereby multiple lamps and multiple junction boxes are arranged in parallel series;
at least one anchor portion disposed on the pair of lamp holders, or the at least one junction box, or both, the at least one anchor portion adapted to receive at least one cable; and
a power cord adapted to extend between the circuitry and an external power source.

In another aspect, the at least one lamp is a light emitting diode.

In another aspect, the at least one lamp has a tubular shape.

In another aspect, the shield is a semi-circular metal panel.

In another aspect, the shield covers about half the lamp sidewall.

In another aspect, the pair of lamp holders comprises a lid.

In another aspect, the first mating surface is an elongated slot.

In another aspect, the adjustable retention member is a tab and a threaded screw.

In another aspect, the at least one junction box comprises a junction box cover.

In another aspect, the second mating surface is an elongated ridge.

In another aspect, the anchor portion is a hole having a rubber perimeter.

In another aspect the switch is adapted to open and close the circuitry to electrical current.

In another aspect, the circuitry comprises a live wire and a null wire.

In another aspect, the cable is a chain cable that attaches to a ceiling.

In another aspect, the assembly comprises an external power source.

In another aspect, the assembly comprises a power cord adapted to extend between the at least one junction box and the external power source.

One objective of the present invention is to provide LED lamps that do not require a housing.

Another objective is to provide LED lamps that direct light away from the ceiling and towards the ground.

Yet another objective is to eliminate uneven light distribution and brightness from LED lamps.

Yet another objective is to eliminate high material and component costs of LED housings.

Yet another objective is to restrict lateral slippage of LED lamps with tabs and threaded screws at the termini of the lamps.

Yet another objective is to easily hang an LED lamp from the ceiling through use of an anchor portion at the termini of the LED lamp.

Yet another objective is to provide a junction box cover and a lid for the lamp holder to inhibit moisture and debris from engaging the circuitry.

Yet another objective is to provide an LED lamp that reduces difficult and time-consuming assembly, and cumbersome housing configurations that hamper installation and thus prevent custom applications.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a bottom angle perspective view of an exemplary modular illumination assembly, in accordance with an embodiment of the present invention;

FIG. 2 illustrates a top angle perspective view of an exemplary modular illumination assembly, in accordance with an embodiment of the present invention;

FIG. 3 illustrates a blow up view of an exemplary lamp holder, in accordance with an embodiment of the present invention;

FIG. 4 illustrates a close up view of an exemplary lamp holder, in accordance with an embodiment of the present invention;

FIG. 5 illustrates a perspective view of a lamp holder detached from a lamp, in accordance with an embodiment of the present invention;

FIG. 6 illustrates a perspective view of a lamp holder mounted to a lamp, in accordance with an embodiment of the present invention;

FIG. 7 illustrates a perspective view of an exemplary junction box and a lamp holder detached from a lamp, in accordance with an embodiment of the present invention;

FIG. 8 illustrates a perspective view of the junction box and the lamp holder shown in FIG. 7 mounted to the lamp, in accordance with an embodiment of the present invention;

FIG. 9 illustrates a schematic view of an exemplary modular illumination assembly with one lamp, in accordance with an embodiment of the present invention;

FIG. 10 illustrates a schematic view of an exemplary modular illumination assembly with four lamps, in accordance with an embodiment of the present invention;

FIG. 11 illustrates a bottom angle perspective view of an exemplary modular illumination assembly with two lamps, in accordance with an embodiment of the present invention;

FIG. 12 illustrates a top angle perspective view of an exemplary modular illumination assembly with two lamps, in accordance with an embodiment of the present invention;

FIG. 13 illustrates a bottom angle perspective view of an exemplary modular illumination assembly with three lamps, in accordance with an embodiment of the present invention;

FIG. 14 illustrates a top angle perspective view of an exemplary modular illumination assembly with three lamps, in accordance with an embodiment of the present invention;

FIG. 15 illustrates a bottom angle perspective view of an exemplary modular illumination assembly with four lamps, in accordance with an embodiment of the present invention.; and

FIG. 16 illustrates a top angle perspective view of an exemplary modular illumination assembly with four lamps in accordance with an embodiment of the present invention.

Like reference numerals refer to like pans throughout the various views of the drawings.

### DETAILED DESCRIPTION OF THE INVENTION

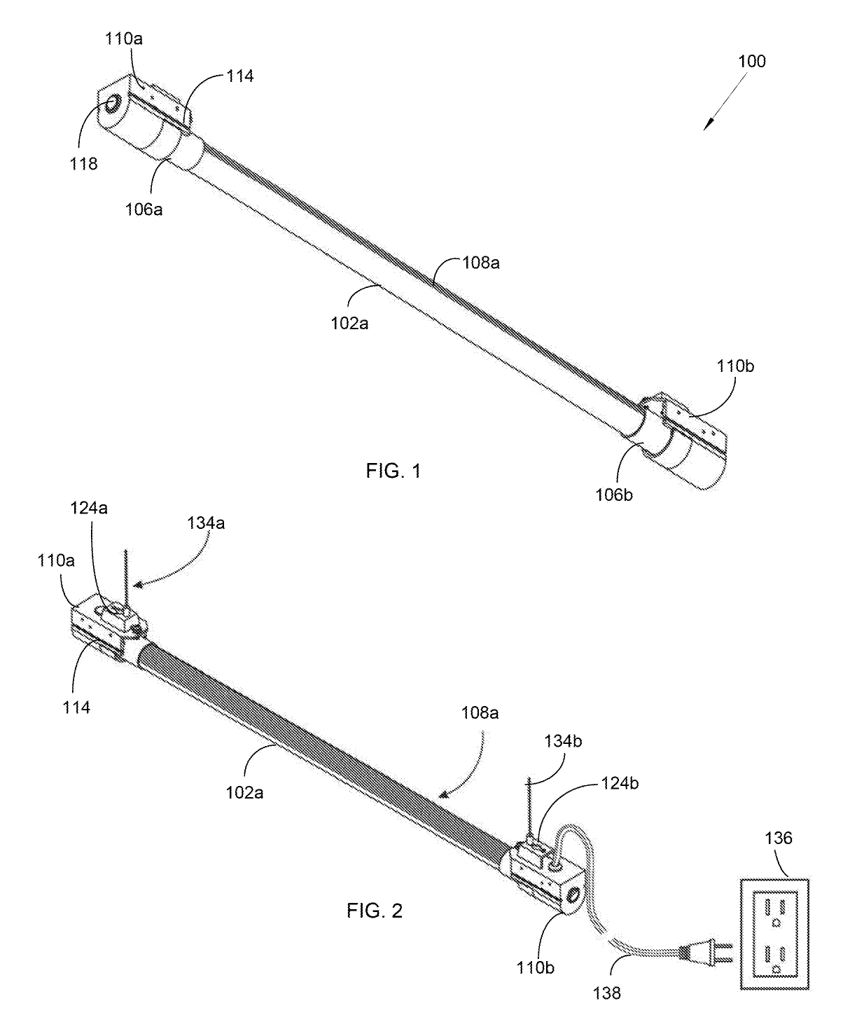

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the, disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply, exemplary embodiments of the inventive concepts defined in the appended claims, Specific dimensions and other physical characteristics relating to the embodiments disclosed herein are therefore not to be considered as limiting, unless the claims expressly state otherwise.

A modular illumination assembly 100 is referenced in FIGS. 1-16. The modular illumination assembly 100, hereafter “assembly 110” is configured to enable at least one light emitting diode (LED) lamp 102a-d to operatively connect in parallel series each other through use of at least one junction box 128a-f that connects the lamps 102a-d in succession. The unique aspect of the assembly 100 is that a housing is not required for supporting and covering the lamps 102a-d. Rather, a pair of lamp holders 110a-h at the termini of the lamps 102a-d firmly retain the lamps position.

The junction boxes 128a-f regulate electrical current and connect the lamps 102a-d, while at least one cable 134a-d hangs the lamps 102a-d from the ceiling. In addition, the light that emanates from the lamps 102a-d is directionally guided away from the ceiling and towards the walls and floor with a shield 108a-d that at least partially covers the lamp 102a-d, so as to create optimal light efficiency. Thus, by not using a special housing to cover and support the lamps 102a-d, space is saved, material is saved, and aesthetics are enhanced.

Turning now to FIG. 2, the assembly 100 provides at least one elongated LED lamp 102a that is adapted to join multiple LED lamps 102b, 102c, 102d in a parallel arrangement, through connecting junction boxes 128a-f. A shield 108a-d at least partially covers the LED lamp 102a, so as to directionally guide the emitted light in a desired direction, such as towards a ground surface. A pair of lamp holders 110a-h retain the lamp 102a in position. A circuitry 116 and a switch 118 control electrical regulation for operation of the LED lamps 102a-d. The lamp holders 110a-h comprise an adjustable retention member 122a, 122b to fasten the termini of the LED lamp 102a-d. The retention members 122a, 122b include a tab 122a and a threaded screw 122b that restrict lateral slippage by the lamp 102a-d.

The lamp holders 110a-h also comprise an anchor portion 124a-d that is sized and dimensioned to receive the at least one cable 134a-d for hanging the LED lamp 102a-d from a ceiling. The junction box 128a-f forms an elongated ridge, and the lamp holder 110a-h forms an elongated slot. The ridge and the slot slidably engage to enable detachable attachment between the junction box 128a-f and the lamp holder 110a-h. In this manner, multiple LED lamps 102a-d may be arranged in parallel series.

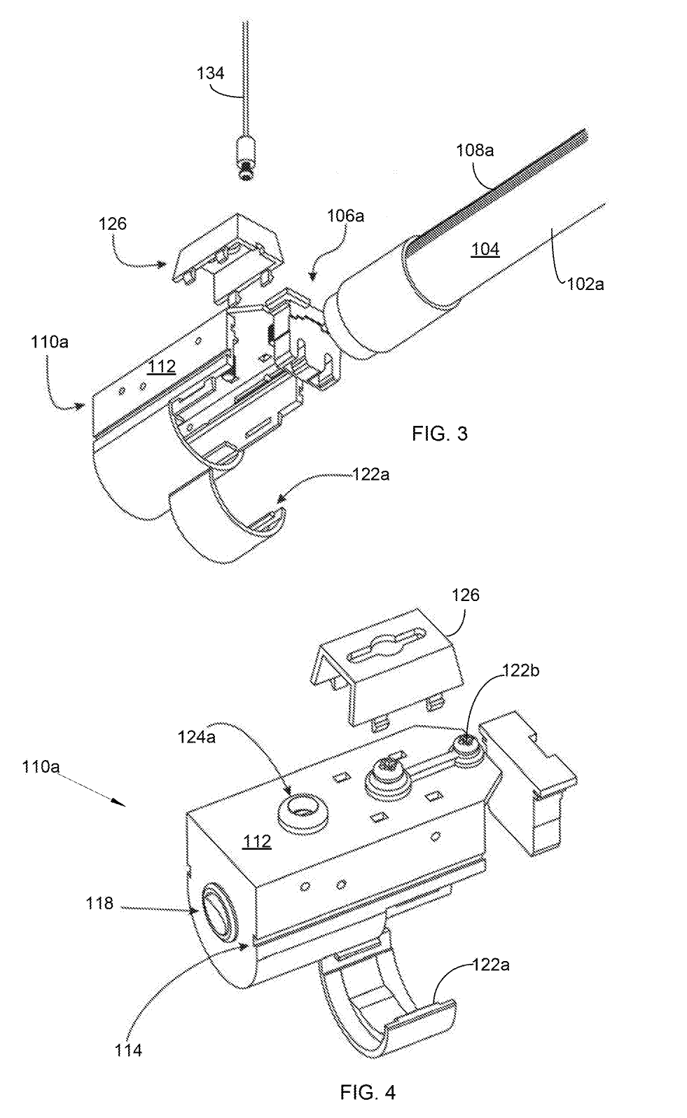

As referenced in FIG. 3, the assembly 100, comprises at least one elongated lamp 102a-d that is operational to emanate light. In one embodiment, the lamp 102a-d comprises an LED. Though in other embodiments, any halogen or light illuminating device may be used. The lamp 102a-d is defined by a lamp sidewall 104 and a pair of lamp terminal walls 106a, 106b that form a cavity. The at least one lamp 102a-d has a tubular shape. The lamp sidewall 104 may be transparent glass. The cavity within the lamp sidewall 104 may contain a filament, wiring, and halogen gases that generates a light when electrical current pass through. The generated light may be any color known in the art.

In some embodiments, a shield 108a-d is disposed along a portion of the lamp sidewall 104. In one embodiment, the shield 108a-d is a semi -circular metal panel that covers at least half the surface area of the lamp sidewall 104. The shield 108a-d directionally guides the light emanating from the at least one elongated lamp 102a-d. The shield 108a-d can be adjusted to cover any amount of the lamp sidewall 104 and rotatably oriented around the lamp sidewall 104 to direct the light in multiple directions and intensities.

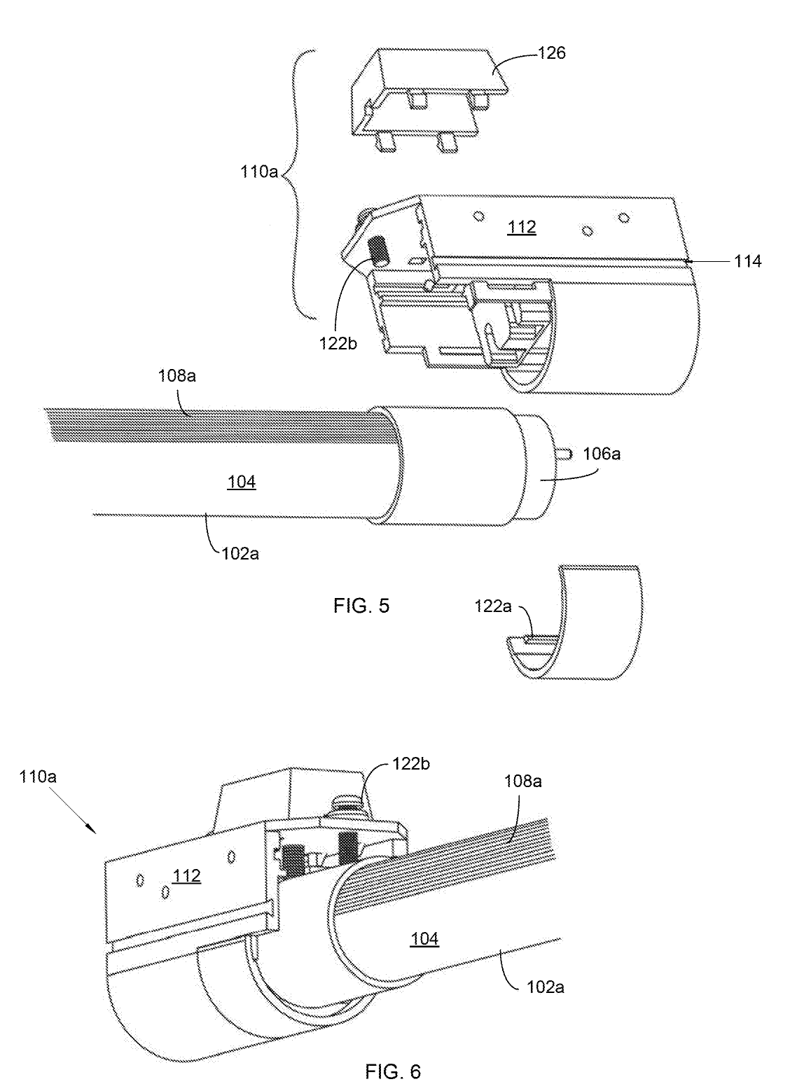

Turning now to FIG. 4, a pair of lamp holders 110a-d engage the pair of lamp terminal walls 106a, 106b to snugly retain the lamp 102a in an operational position. The lamp holders 110a-d are defined by a holder sidewall 112. The holder sidewall 112 may form a generally rectangular shape containing a cavity, A circuitry 116 and the switch 118 pass through the cavity in the lamp holder 110a-d. In one embodiment, the holder sidewall 112 forms a first mating surface 114 that is used to connect multiple lamps 102a-d and junction boxes 28a-f in parallel series, as described below. FIG. 5 illustrates the first mating surface 114 as an elongated slot. Perforations may be adapted along the elongated slot to enhance grip with a second mating surface 132.

As shown in the blow up view of FIG. 6, the lamp holders 110a-d comprise a circuitry 116 and a switch 118 for operation of the at least one elongated lamp 102a-d. In one embodiment, the circuitry 116 is a series of wires, resistors and transformers known in the arts to carry electrical current for operation of an LED lamp 102a. In one embodiment the circuitry 116 comprises a live wire 120a, or hot wire, and a null wire 120b, or ground. The switch 118 is adapted to open and close the circuitry 116 to regulate electrical current, i.e. turn on and off the light. The switch 118 may include a button that is the placed between an On position and an Off position. The position of the switch 118 near the lamp terminal wall 106a-b and facilitates access or powering on and off the LED lamp 102a-d.

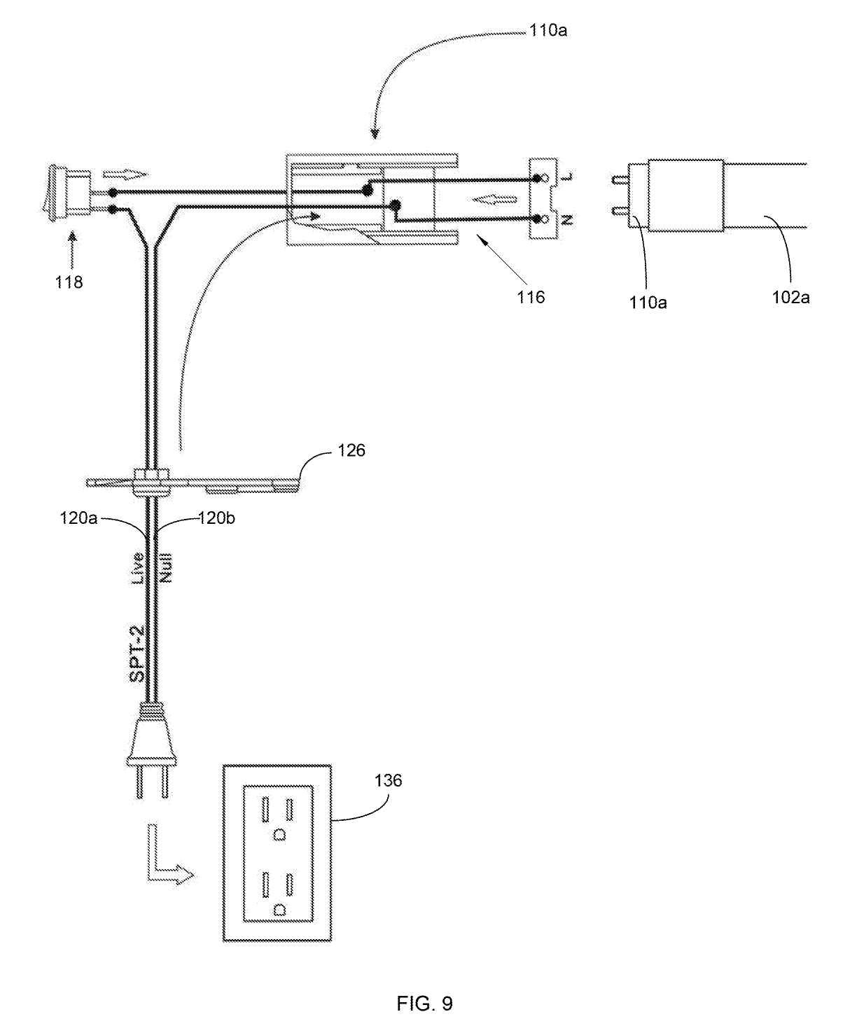

Looking ahead to FIG. 9, the assembly 100 comprises an external power source 136 that provides the electrical current for the lamp 102a-d. The external power source 136 may include an AC socket, known in the art to provide electrical power to light sources. In some embodiments, the assembly 100 provides a power cord 138 that is adapted to extend between the junction box 128a-f and the external power source 136. In one embodiment, the power cord 138 is an SPT-2 wire cord. Though other types of power cords may be used. In one alternative embodiment, a battery may be used to power the lamp 102a-d .

Looking again at FIG. 3, the pair of lamp holders 110a-h comprises a lid 126. The lid 126 forms a seal for a cavity in the lamp holder 110a-h, so as to inhibit moisture and debris from reaching the circuitry 116 and the switch 118. The pair of lamp holders 110a-h further comprising an adjustable retention member 122a, 122b for adjustably fastening the pair of lamp terminal walls 106a, 106b to restrict lateral slippage by the at least one elongated lamp 102a-d. In one embodiment, the adjustable retention member 122a, 122b is a tab and a threaded screw. The tab forms a friction fit relationship with the terminal ends of the lamp 102a-d. The threaded screw can be rotated clockwise or counterclockwise to secure or loosen the lamps 102a-d from their respective lamp holders 110a-h.

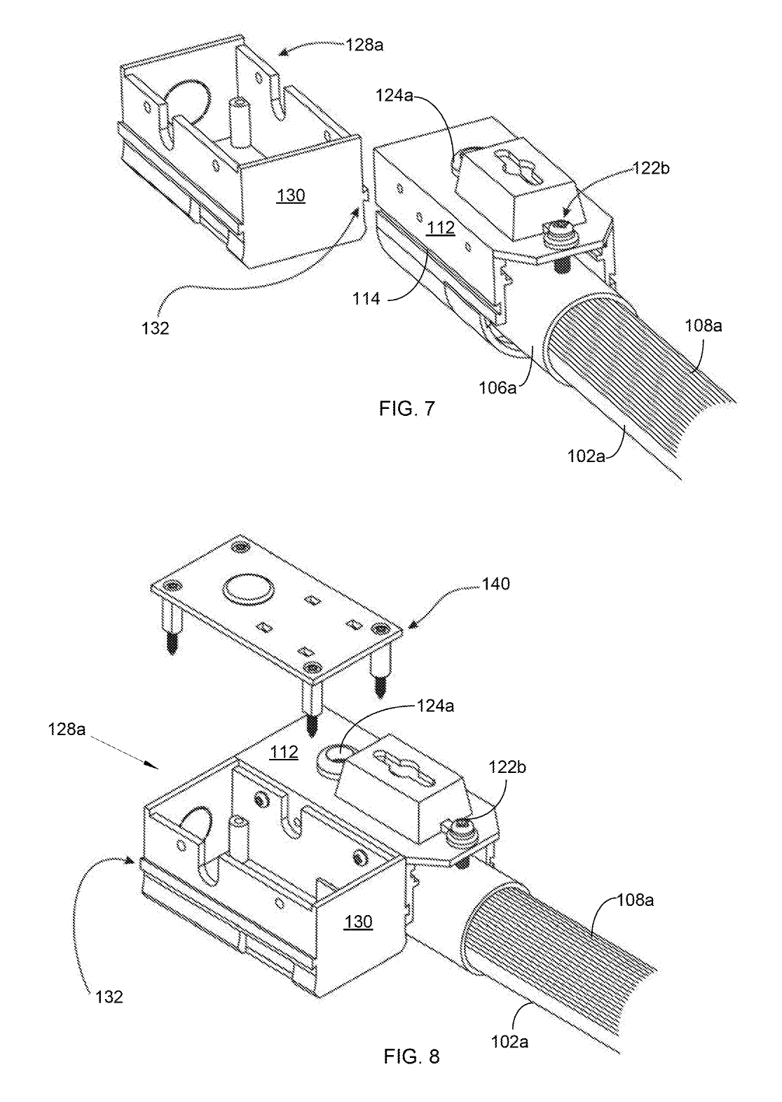

As referenced in FIG. 7, the assembly 100 provides at least one junction box 128a-f. The junction box 128a-f is operational to regulate electrical current to the at least one elongated lamp 102a-d. In essence, the junction box 128a-f serves as a receptacle retain and orient wires, splices, and other electrical components that feed into the LED lamp 102a-d.

Looking at FIG. 8, the junction box 128a-f comprises a junction box cover 140. The junction box cover 140 forms a seal with a cavity in the junction box 128a-f, so as to inhibit moisture and debris from reaching the circuitry 116 contained therein. Screws may be used to fasten junction box cover 140 in place.

Turning again to FIG. 8, the junction box 128a-f may be defined by a junction box sidewall 130, forming a generally rectangular shape. The junction box sidewall 130 is defined by a second mating surface 132. In some embodiments, the second mating surface 132 is an elongated ridge that runs along the length of the junction box 128a-f. Though in other embodiments, the second mating surface 132 may include, without limitation, a latch, a friction fit mechanism, a magnet, a screw, and an adhesive.

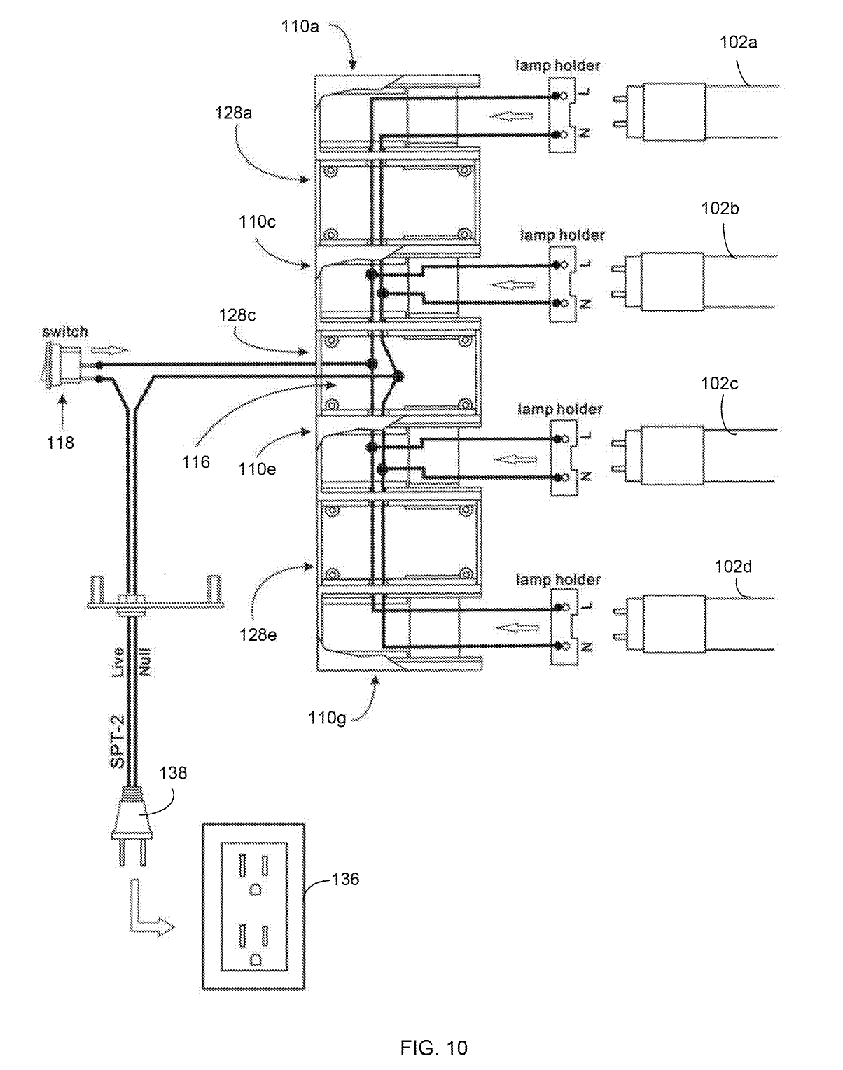

The first mating surface 114 of the lamp holders 110a-h detachably mates with the second mating surface 132 of the junction box 128a-f in a slidable relationship. In this manner, multiple lamp 102a-ds and multiple junction boxes 128a-f may be easily arranged in parallel series. In some embodiments, multiple lamp 102a-ds are joined in parallel through multiple junction boxes 128a-f. This is illustrated in the schematic diagram of FIG. 10. Here, three junction boxes 128a, 128c, 128e are operationally connected to the circuitry 116 and the switch 118 of the lamp holders 110a, 110c, 110e, 110g.

The lamp holders 110a-h or the junction box 128a-f may detachably attach to at least one anchor portion 124a-d that is adapted to receive at least one cable 134a-d. The cable 134a-d enables the lamp 102a-d to hang from a ceiling or other mounting surface. In some embodiments the anchor portion 124a-d is defined by a hole having a rubber perimeter. The cable 134a-d extends from the ceiling to attach to the anchor portion 124a-d, and thereby allow the lamp 102a-d to hang from the ceiling without requiring a large housing to mount the lamp 102a-d .

In one embodiment, the cable 134a-d is a chain cable that attaches to a ceiling from a first end, and to the anchor portion 124a-d from a second end. The cable 134a-d can be length adjusted. Also, the cable 134a-d can swing freely from the ceiling. This flexible mounting capability allows the assembly 100 to hang from different sizes and dimensions of ceiling, and also be operational in different types of buildings.

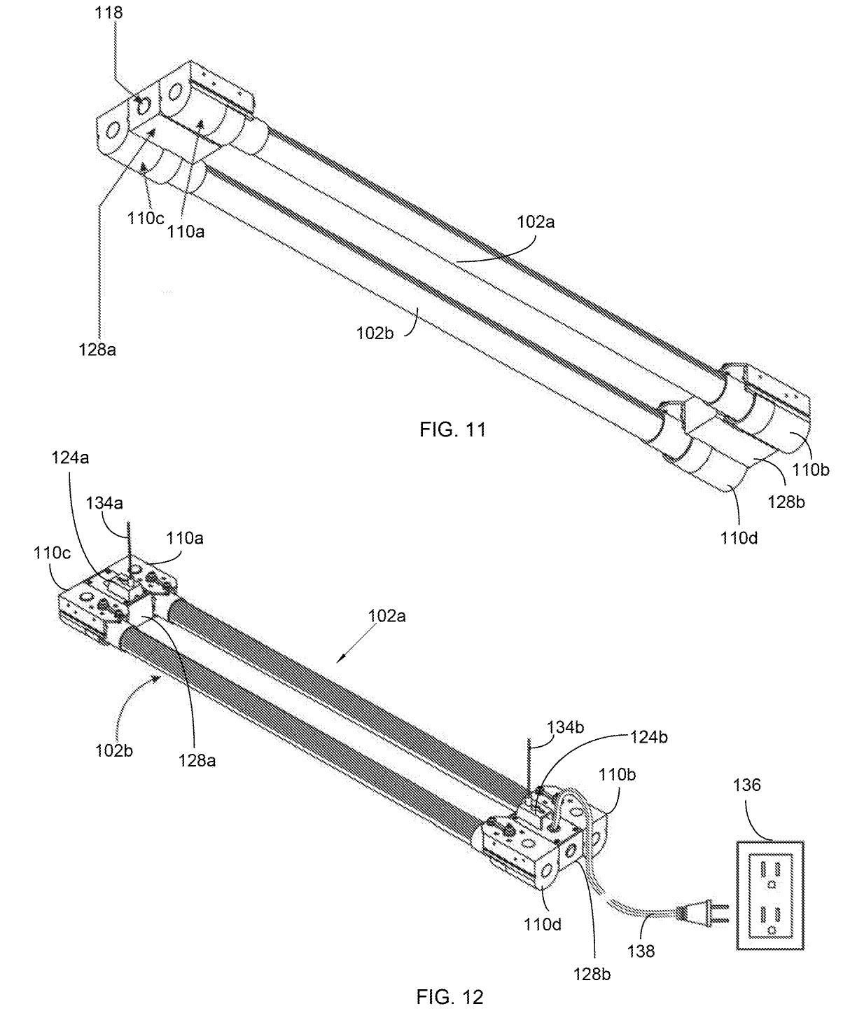

As discussed above, the first mating surface 114 of the lamp holders 110a-h detachably mates with the second mating surface 132 of the junction box 128a-f. In this manner, multiple lamp 102a-ds and multiple junction boxes 128a-f are arranged in parallel series. For example, FIGS. 11 and 12 illustrate upper and lower perspective view of two LED lamp 102a-ds arranged in parallel series with one pair of junction boxes 128a-f operational between two corresponding LED lamp 102a-ds.

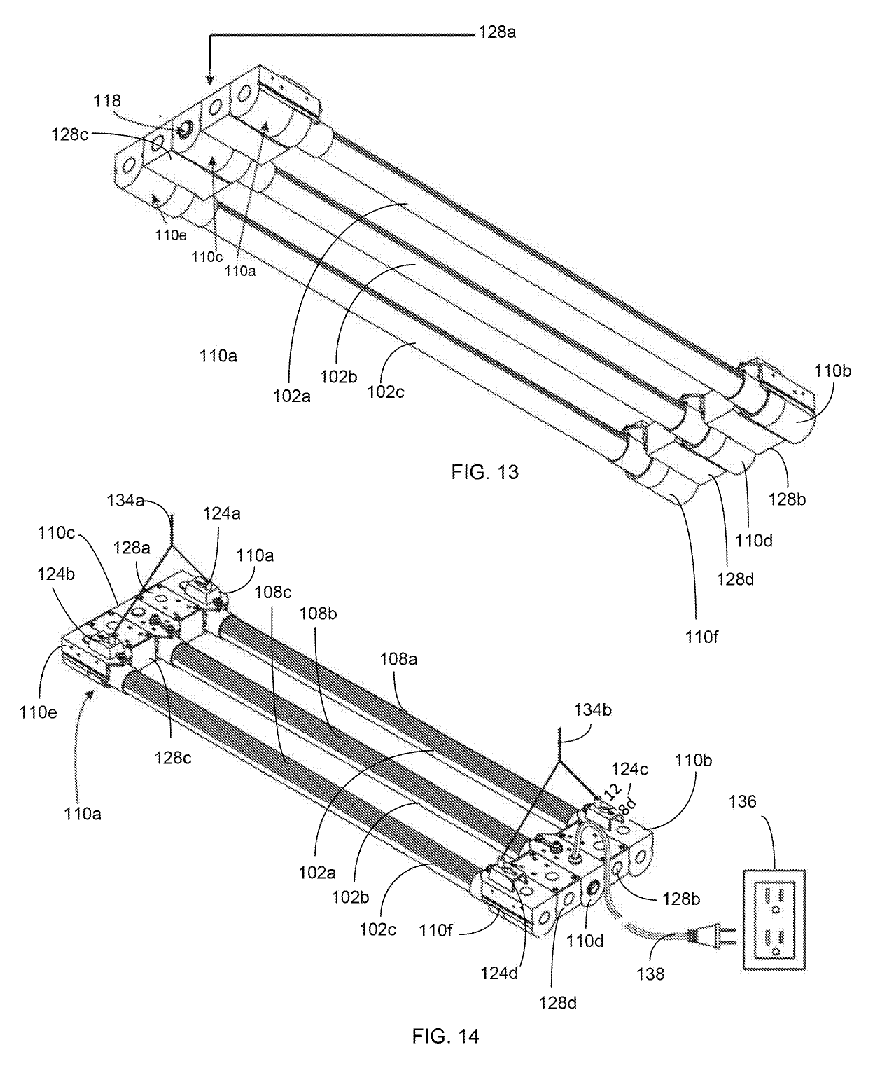

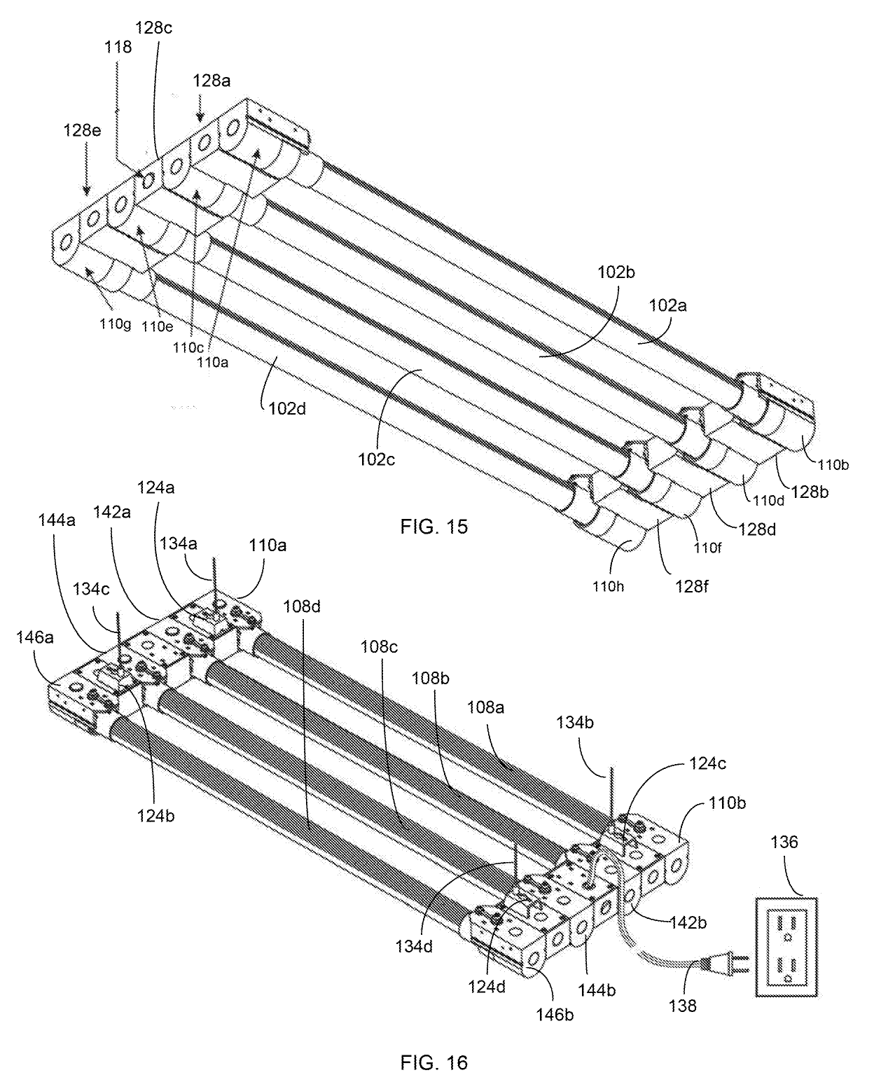

Additionally, FIGS. 13 and 14 illustrate upper and lower perspective view of three LED lamps 102a, 102b, 102c arranged in parallel series with two pairs of junction boxes 128a, 128b, 128c, 128d operational between three corresponding LED lamps 102a-c. Furthermore, FIGS. 15 and 16 illustrate upper and lower perspective view of four LED lamps 102a-d arranged in parallel series with three pairs of junction boxes 128a, 128b, 128c, 128d, 128e, 128f operational between four corresponding LED lamps 102a-d. In all of these multi-lamp 102a-d arrangements, a switch 118 is operational at the lamp holders 110a-h or the junction boxes 128a-f, and the cable 134a-d supports the entire assembly 100 from the anchor portion 124a, 124b, 124c, 124d disposed at the lamp holder 110a-h, or the junction boxes 128a-f, or both.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A modular illumination assembly, the assembly comprising:
at least one lamp operational to emanate light, the at least one lamp defined by a lamp sidewall and a pair of lamp terminal walls that form a cavity;
a shield disposed along a portion of the lamp sidewall,
whereby the shield directionally guides the light emanating from the at least one lamp;
a pair of lamp holders retaining the pair of lamp terminal walls, the pair of lamp holders defined by a holder sidewall that forms a first mating surface, the pair of lamp holders comprising at least one adjustable retention member;
a circuitry and a switch for operation of the at least one lamp, the circuitry and the switch operatively connected to the pair of lamp holders and the at least one lamp;
at least one junction box defined by a junction box sidewall that forms a second mating surface, the at least one junction box operationally connected to the circuitry and the switch, the at least one junction box operational to regulate electrical current to the at least one lamp,
whereby the first mating surface of the pair of lamp holders detachably mates with the second mating surface of the at least one junction box,
whereby multiple lamps and multiple junction boxes are arranged in parallel series; and
at least one anchor portion disposed on the pair of lamp holders, or the at least one junction box, or both.

2. The assembly of claim 1, wherein the at least one lamp is a light emitting diode.

3. The assembly of clan 1, wherein the at least one lamp has a tubular shape.

4. The assembly of claim 1, wherein the shield is a semi-circular metal panel.

5. The assembly of claim 1, wherein the shield is adapted to cover about half the lamp sidewall.

6. The assembly of claim 1, wherein the pair of lamp holders comprises a lid.

7. The assembly of claim 1, wherein the first mating surface is an elongated slot.

8. The assembly of claim 1, wherein the at least one adjustable retention member comprises a tab and a threaded screw.

9. The assembly of claim 1, wherein the at least one adjustable retention member is adapted for fastening the pair of lamp terminal walls to restrict lateral slippage by the at least one elongated lamp.

10. The assembly of claim 1, wherein the at least one junction box comprises a junction box cover.

11. The assembly of claim 1, wherein the second mating surface is an elongated ridge.

12. The assembly of claim 1, wherein the switch is adapted to open and close the circuitry to electrical current.

13. The assembly of claim 1, wherein the circuitry comprises a live wire and a null wire.

14. The assembly of claim 1, wherein the at least one anchor portion is defined by a hole having a rubber perimeter.

15. The assembly of claim 14, further comprising at least one cable adapted to join with the at least one anchor portion.

16. The assembly of claim 15, wherein the at least one cable is a chain cable that attaches to a ceiling.

17. The assembly of claim 1, further comprising an external power source.

18. The assembly of claim 17, further comprising a power cord adapted to extend between the circuitry and the external power source.

19. A modular illumination assembly, the assembly comprising:
at least one elongated lamp operational to emanate light, the at least one lamp defined by a lamp sidewall and a pair of lamp terminal walls that form a cavity, the at least one lamp comprising a light emitting diode;
a shield disposed along a portion of the lamp sidewall, the shield being adapted to cover about half the lamp sidewall,
whereby the shield directionally guides the light emanating from the at least one lamp;
a pair of lamp holders retaining the pair of lamp terminal walls, the pair of lamp holders defined by a holder sidewall that forms a first mating surface, the pair of lamp holders comprising at least one adjustable retention member;
a circuitry and a switch for operation of the at least one lamp, the circuitry and the switch operatively connected to the pair of lamp holders and the at least one lamp;
at least one junction box defined by a junction box sidewall that forms a second mating surface, the at least one junction box operationally connected to the circuitry and the switch, the at least one junction box operational to regulate electrical current to the at least one lamp,
whereby the first mating surface of the pair of lamp holders detachably mates with the second mating surface of the at least one junction box,
whereby multiple lamps and multiple junction boxes are arranged in parallel series;
at least one anchor portion disposed on the pair of lamp holders, or the at least one junction box, or both, the at least one anchor portion adapted to receive at least one cable; and
a power cord adapted to extend between the circuitry and an external power source.

20. A modular illumination assembly, the assembly consisting of:
at least one elongated light emitting diode lamp operational to emanate light, the at least one light emitting diode lamp defined by a lamp sidewall and a pair of lamp terminal walls that form a cavity;
a shield disposed along a portion of the lamp sidewall, the shield being adapted to cover about half the lamp sidewall,
whereby the shield directionally guides the light emanating from the at least one light emitting diode lamp;
a pair of lamp holders retaining the pair of lamp terminal walls, pair of lamp holders comprising a lid, the pair of lamp holders defined by a holder sidewall that forms an elongated slot, the pair of lamp holders comprising at least one adjustable retention member, the at least one adjustable retention member comprising a tab and a threaded screw;
a circuitry and a switch for operation of the at least one light emitting diode lamp, the circuitry and the switch operatively connected to the pair of lamp holders and the at least one light emitting diode lamp;
at least one junction box defined by a junction box sidewall that forms an elongated ridge, the at least one junction box comprising a junction box cover, the at least one junction box operationally connected to the circuitry and the switch, the at least one junction box operational to regulate electrical current to the at least one light emitting diode lamp,
whereby the first mating surface of the pair of lamp holders detachably mates with the second mating surface of the at least one junction box,
whereby multiple light emitting diode lamps and multiple junction boxes are arranged in parallel series;
at least one anchor portion disposed on the pair of lamp holders, or the at least one junction box, or both, the at least one anchor portion adapted to receive at least one cable; and
a power cord adapted to extend between the circuitry and an external power source.
